(19) United States
(12) Patent Application Publication
(10) Pub. No.: US 2018/0036584 A1
(43) Pub. Date: Feb. 8, 2018

(54) THREE DIMENSIONAL BODY MOVEMENT STRUCTURE

(71) Applicant: Joseph Andrew Kleman, Raleigh, NC (US)

(72) Inventor: Joseph Andrew Kleman, Raleigh, NC (US)

(21) Appl. No.: 15/227,272

(22) Filed: Aug. 3, 2016

(51) Int. Cl. A63B 22/00; G09B 19/00; A63B 23/035

(52) U.S. Cl. CPC A63B 22/0025; A63B 23/035; G09B 19/003; A63B 2022/0092

(57) ABSTRACT

A three dimensional structure that creates improvised movements to break common movement patterns in a subject's body. The structure uses a system that is infinitely configurable through the arrangement of cables and targets. A subject may start a movement on the floor in rolling, and crawling positions. They are given a parameter to follow but not a specific way of making the movement happen.

### BACKGROUND OF THE INVENTION

The present invention relates therapeutic and training apparatus, and more particularly to an apparatus for progressive training of body movements.

During the course of our lifetime we begin to develop body movement patterns that are consistent with injury. Some of these injuries may be caused by lack of use of all muscle patterns available in the body.

Systems currently being used in physical rehabilitation start the patient in exercises that are often too advanced for a post injury patient. These systems are also limited in the sense that a patient is given a set exercise which has the body move in one set direction only.

As can be seen, there is a need for a system and method for body movement training that is infinitely configurable through cables and targets. Patient starts on the floor in rolling, and crawling positions. They are given a parameter to follow but not a specific way of making the movement happen.

### SUMMARY OF THE INVENTION

In one aspect of the present invention a movement training apparatus, includes: a three dimensional frame formed from a plurality of liner frame members and a plurality of end joining members; a cable interconnecting one or more sides of the frame; a plurality of targets carried on the cable; wherein the cable is configurable in a pattern within the frame and the targets are configurable along the cable. The cable may be an elastic cord and the cord may have a fastener at an end of the cable. In some embodiments, the fastener is a snap clip.

According to other aspects of the invention, the plurality of targets carry a visual indicia distinguishing one or more of the plurality of targets from each other. The visual indicia may include one or more of a color, a body shape of the target, a surface texture, and a light. In other embodiments, the plurality of targets emit a unique audible sound for each of the plurality of targets. The cable may extend through a body of the plurality of targets and may have frictional surface contact with the body of the plurality of targets.

In yet other aspects of the invention, a movement training apparatus, includes: an elastic cable configured to attach to one or more sides of a support structure; a plurality of targets having a visual indicia distinguishing one or more of the plurality of targets from each other, the plurality of targets carried on the cable, wherein the cable extends through a body of the plurality of targets, the cable having a frictional surface contact with the body of the plurality of targets; and the targets are selectively positionable along the length of the cable. The support structure may be a frame formed from a plurality of liner frame members and a plurality of end joining members. The plurality of targets may carry a visual indicia distinguishing one or more of the plurality of targets from each other. In some embodiments, each of a plurality of cables carries a plurality of targets having a set of visual indicia, wherein each target in the set has a visual indicia that is distinct from another target in the set.

In yet another aspect of the invention a method of training movement in a three dimensional (3D) environment, includes: providing a three dimensional training structure, having a 3D frame formed from a plurality of liner frame members and a plurality of end joining members; a cable interconnecting one or more sides of the frame; a plurality of targets carried on the cable, wherein the cable is configurable in a pattern within the frame and the targets are configurable along the cable. The method may also include, instructing a subject to perform a body movement to contact one or more of the plurality of targets according a rule.

The method includes evaluating the subject's performance of the body movement according to the rule. In some embodiments, the rule is based on a visual indicia presented by the plurality of targets. In other embodiments, the rule is based on a configured position of the cable carrying the targets.

These and other features, aspects and advantages of the present invention will become better understood with reference to the following drawings, description and claims.

### BRIEF DESCRIPTION OF THE DRAWINGS

FIG. 1 is a perspective view of an embodiment of a 3D Body Movement Structure of the invention.

FIG. 2 is a detail elevation view indicated by line 2-2 of FIG. 1.

FIG. 3 is a side elevation view showing adjustment of a target.

FIG. 4 is a side elevation view of a plurality of targets.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an three dimensional cubic training apparatus to train a person in the execution of complex body muscle movements. The apparatus of the present invention is particularly useful in the patient rehabilitation context, particularly for physical therapy.

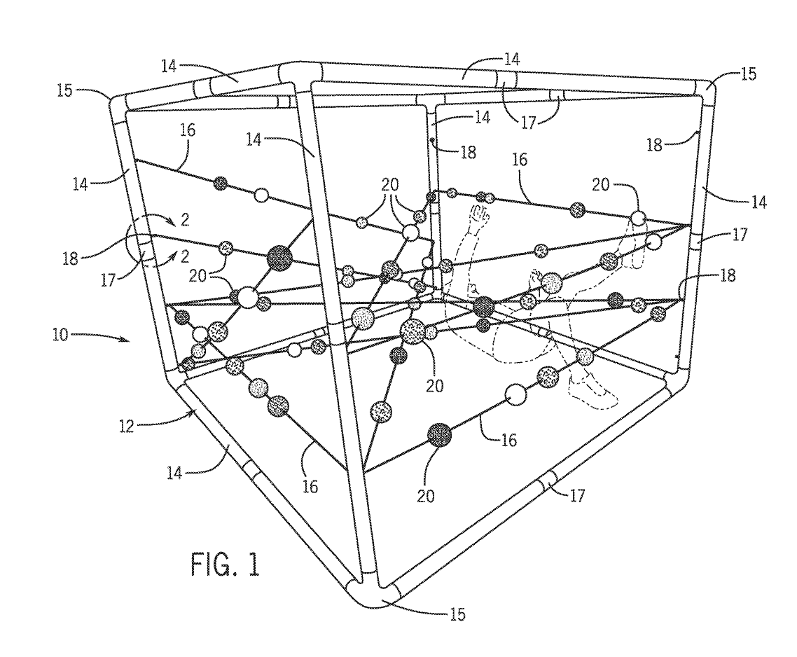

As seen in reference to FIG. 1, a three dimensional body movement structure 10 of the present invention includes a frame 12, formed from a plurality of liner frame members 14 and a plurality of end joining members 15. The linear frame members 14 and end joining members 15 are interconnected to form the three dimensional structure 10, which, for purposes of non-limiting illustration may be in the form of a rectangular or square cube. The linear frame members 14 may also be joined with a coupler 17 so as to span a greater length, or to provide variability in the length or width of the 3D structure.

As will be appreciated, the frame members 14 and joining members 15, and couplers 17, may be selected from any suitable framing material, such as wood, metal, composites, and plastics. By way of non-limiting example, the frame elements may be made from furniture grade poly vinyl chloride (PVC) tubing, and may be permanently joined or they may be releasably assembled to provide portability or configurability to the frame 12. The frame members may be joined with any suitable fastener, such as adhesives, pins, bolts, threaded couplings, and the like.

A plurality of targets 20, such as balls, are suspended in a configurable pattern within the 3D body movement structure 10. The targets 20 may be suspended or carried by a cable assembly 16 interconnecting various points of the 3D structure. The cable assembly 16 is formed of a cable 18, which is preferably made of an elastic or shock cord 18 to permit displacement of the targets 20 carried on the cable 18 as they are contacted by a user of the cube 10.

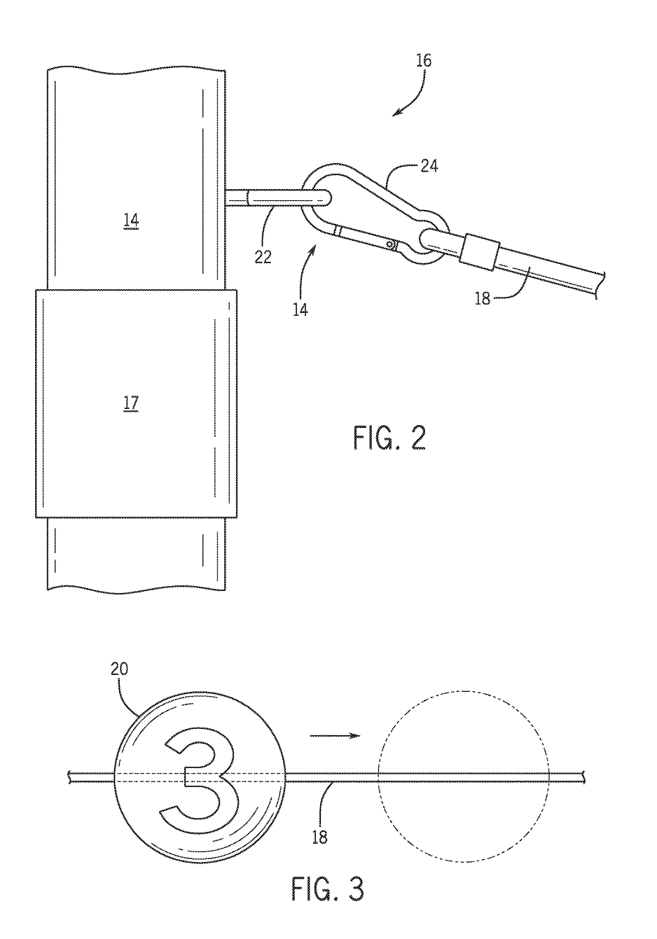

As seen in reference to FIG. 2, the cables 16 may be connected to the frame members 14, 15 via an attachment point 22, which may be hook or eyeloop bolts. The ends of the cable assembly 16 may have a fastener 24, such as a snap clip, to secure the cable assembly 16 to the to the attachment points 22.

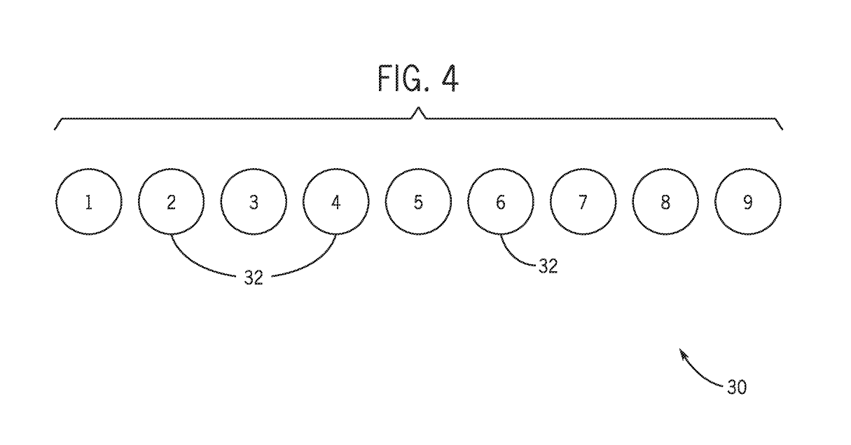

The targets 20 are preferably formed of an assortment of visual indicia, such as colors, surface textures, shapes, and/or numbers to facilitate target 20 identification. Targets 20 may also be electronic, and have an associated light or audio signal that may be operated responsive to touch. As seen in reference to FIGS. 3 and 4, the targets 20 may be carried on the cable 18 by threading the cable 18 through the target 20. The targets 20 should have a frictional interface with the cable 18 to permit displacement along the cable 18 for configuration of the targets 20 on the cable 18, while maintaining the position of the target 20 on the cable 18 when the targets are disposed for use.

The cube 10 is used to develop improvised movements, which fosters developmental sequencing, and rolling patterns to break or train common movement patterns of a subject. The subject may be a rehabilitation patient, an athlete, or other user desiring to develop movement skills. The subject is given a rule, which may be a parameter or sequence of parameters, specifying one or more designated targets 20 they must acquire to perform a movement. The parameters may be based on one or more visual indicia on the targets 20, or a designation of one or more cables carrying the targets. The subject must then touch the specified targets 20 following the rule given. The subject may also be given temporal parameters for performance of the specified movement.

For rehabilitative subjects, the 3D frame 10 of the present invention may be utilized to start the subject with a regression to infant style movements and then progresses the subject through improvised movements, thereby rebuilding the subject's body movement systems, both physical and cognitive, in an easier more comprehensive way, reconnecting the mind body connection through movement. The patient becomes tired of the same exact movement and discontinues PT or rehab to do same movements on their own at home, or never finishes.

The cube 10 provides a system that is infinitely configurable through the selection and placement of cables 16 and targets 20. Referring again to FIG. 1, for a rehabilitation patient, the subject may start on the floor, executing rolling and crawling movement positions. They are given a parameter to follow but not a specific way of making the movement happen.

The 3D movement structure 10 may also be utilized as a movement based training method to help with sports performance, core stability and integration, rehabilitation, and over all better movement of the body. The system works through one or more of instinctive movements, improvised movements, and rolling patterns.

The method was designed based on using a form of dancing called “Contact Improv”. It is a form of dance where the movement is improvised either solo or in multiples. In the learning process of discovering new movements there are parameters or scores set that the subject must follow or attempt to follow. This creates a mind body connection that you have to use instinctual movement to create a dance.

The instinctual movement that Contact Improv promotes new movement patterns in the body that in our normal everyday life we wouldn't try or need. So the cube system uses a variation of targets in a 3D space that encourages the client to move to those targets based on the rule they are given.

As indicated previously, timing can be set to where the subject is required to move faster or slower from target 20 to target 20. For an example an 80 year old client that would want to move better again would have an increased amount of time to move from the floor to the next target 20. A professional level athlete, such as an Olympian, may have a shorter time span to negotiate the targets 20.

The spacing of the cables can be set closer together or further apart for a more dynamic movement as opposed to close methodical ones. The size of the cube may be selected for use in a hospital setting for beginning stages of rehab from a stroke for example or trauma to restore the movement systems of the body. For example, for subjects that are bed ridden, the bed can be wheeled into the cube and cables can be adjusted at a height to let the patient begin simple hand eye coordination exercises to begin movement and coordination practices again. As the subject progresses, increasing the technical aspects of the targets 20 based on height, angles, and distance apart the cube 10 can be readily reconfigured to change and make movements more difficult.

The cube 10 of the present invention can also be used with children or adults with coordination issues with crossing midlines. The parameters can be set where each target obtained has to be from crossing over the body from right to left, or right to left in order to achieve the task. With the options practically endless the uses of such a device could present great value in performance of athletes down to a fun exercise for kids to accomplish to help with development hold ups.

As will be appreciated, the cube 10 size can be changed dimensionally where the frame members 14 may be telescopic to change the challenge or ease of the exercise to work with small children that cannot reach 7 feet. Adjustability will also allow configuration for a high level athlete to almost reach the target but giving up to soon. This can be done using a projection into the cube or through a hardwired computer scoring system. Another way to present the system is by a holographic projection of the targets and scoring of performance. The use of movement sensors on the athlete or client can help determine common movement dysfunctions or patterns, so the next parameter can be set to help correct the bad movement pattern or increase the intensity.

First steps past set up would be to have the client tested for their ability of movement. This could be core stability, integration and balance. Someone that would be lacking stability in movements or comfort would want to start lower to the floor. This will take out the bodies feeling of danger and allow the body to move freely using the muscles it was designed to use in that movement. Another to take into consideration upon use is age and potential prior injuries.

From this point the cables would be set up accordingly to height, and challenge desired for the client. The client may then lay on their back flat in the center of the cube, or other desired start position. The practitioner would then instruct them on a movement score or rule to follow. For example: Touch all red targets with your right hand, and blue targets with your left hand. You must alternate and cross over your mid line to reach each target. This would help in correcting coordination and mid line dysfunction in the movement.

The system would still be working based on repetition of use. So the more the client would spend time in the cube the more benefit would be seen. Keeping the rules fresh each time keeps the brain thinking and moving at the same time.

Additionally, the cube can be used in sports performance, rehabilitation, exercise and even potentially as an arcade game in embodiments made electronic for scoring.

It should be understood, of course, that the foregoing relates to exemplary embodiments of the invention and that modifications may be made without departing from the spirit and scope of the invention as set forth in the following claims.

What is claimed is:

1. A movement training apparatus, comprising:
a three dimensional frame formed from a plurality of liner frame members and a plurality of end joining members;
a cable interconnecting one or more sides of the frame;
a plurality of targets carried on the cable;
wherein the cable is configurable in a pattern within the frame and the targets are configurable along the cable.

2. The movement training apparatus of claim 1, wherein the cable is a cable assembly, comprising:
an elastic cord.

3. The movement training apparatus of claim 2, wherein the cable assembly further comprises a fastener operatively attached to an end of the cable.

4. The movement training apparatus of claim 3, wherein the fastener is a snap clip.

5. The movement training apparatus of claim 1, wherein the plurality of targets carry a visual indicia distinguishing one or more of the plurality of targets from each other.

6. The movement training apparatus of claim 5, wherein the visual indicia comprises one or more of a color, a body shape of the target, a surface texture, and a light.

7. The movement training apparatus of claim 6, wherein the plurality of targets emit an audible sound.

8. The movement training apparatus of claim 1, wherein the cable extends through a body of the plurality of targets.

9. The movement training apparatus of claim 3, wherein the cable has a frictional surface contact with the body of the plurality of targets.

10. A movement training apparatus, comprising:
an elastic cable configured to attach to one or more sides of a support structure;
a plurality of targets having a visual indicia distinguishing one or more of the plurality of targets from each other, the plurality of targets carried on the cable, wherein the cable extends through a body of the plurality of targets, the cable having a frictional surface contact with the body of the plurality of targets; and the targets are selectively positionable along the length of the cable.

11. The movement training apparatus of claim 10, wherein the support structure is a frame formed from a plurality of liner frame members and a plurality of end joining members.

12. The movement training apparatus of claim 10, wherein the targets are selectively positionable along a longitudinal length of the cable.

13. The movement training apparatus of claim 12, wherein the plurality of targets carry a visual indicia distinguishing one or more of the plurality of targets from each other.

14. The movement training apparatus of claim 13, wherein each of a plurality of cables carries a plurality of targets having a set of visual indicia, wherein each target on one of the plurality cables have a visual indicia that is distinct from another target carried on the one of the plurality of cables.

15. A method of training movement in a three dimensional (3D) environment, comprising:
providing a three dimensional training structure, comprising:
a three dimensional frame formed from a plurality of liner frame members and a plurality of end joining members;
a cable interconnecting one or more sides of the frame;
a plurality of targets carried on the cable, wherein the cable is configurable in a pattern within the frame and the targets are individually configurable along the cable.

16. The method of claim 15, further comprising:
instructing a subject to perform a body movement to contact one or more of the plurality of targets according a rule.

17. The method of claim 16, further comprising:
evaluating the subject's performance of the body movement according to the rule.

18. The method of claim 16, wherein the rule is based on a visual indicia presented by the plurality of targets.

19. The method of claim 18, wherein the rule is based on a configured position of the cable carrying the target.
